(19) United States
(12) Patent Application Publication
(10) Pub. No.: US 2005/0225828 A1
(43) Pub. Date: Oct. 13, 2005

(54) Electro-optic modulators incorporating quantum dots

(75) Inventors: Nick Zakhleniuk, Colchester (GB); Anthony James Holden, Brackley (GB)

Correspondence Address: LAHIVE & COCKFIELD, LLP., 28 STATE STREET, BOSTON, MA, 02109, US

(73) Assignee: BOOKHAM TECHNOLOGY, PLC, Abingdon (GB)

(21) Appl. No.: 10/509,354

(22) PCT Filed: Mar. 27, 2003
(86) PCT No.: PCT/GB03/01361

§ 371 Date: Sep. 27, 2004

(30) Foreign Application Priority Data
Mar. 27, 2002 (GB) 0207166.0

(51) Int. Cl. G02F 1/03

(52) U.S. Cl. 359/247; 359/248

(57) ABSTRACT

A modulator is formed of a semiconductor material which utilises the electro-optic effect to achieve a change in the refractive index Δn of the material under the influence of an applied electrical field F (251), in accordance with the equation: Δn=−½ n₀³ [rF+sF²]≡Δn_{L}+Δn_{Q} where n₀ is the refractive index of the material at zero field, and Δn_{L} and Δn_{L} and Δn_{Q} are the linear and quadratic contributions to the change in refractive index respectively, r is the linear electro-optic coefficient of the material and s is the quadratic electro-optic coefficient of the material incorporating a plurality of quantum dots and operating in a wavelength region where the value of rF is sufficiently greater than the value of sF² so as to operate with the dominant effect on the refractive index Δn being contributed by the linear effect. In this way, a device with a wide bandwidth is achieved by appropriately separating the band-gap wavelength (λ_{g}) and the operating wavelengths (λ).

This invention relates to electro-optic modulators and has particular reference to electro-optic modulators incorporating quantum dots for use, for example, in Mach-Zehnder interferometers (MZIs).

### BACKGROUND

In this specification the term “light” will be used in the sense that it is used in optical systems to mean not just visible light but also electromagnetic radiation having a wavelength between 800 nanometres (nm) and 3000 nm.

The present invention is concerned with a modulator for modulating an extant laser beam. The concept of integrated optical (or ‘photonic’) circuits utilising a modulator to modulate a laser light beam is not new but, until recently, commercial—and hence telecom systems—use was limited to relatively simple devices, primarily lithium-niobate modulators, which are available from several commercial sources. However, lithium niobate is a ferro-electric material unsuitable for monolithic integration such as desired for mass production of large scale integrated products to drive down unit cost. Hence, more recent electro-optic modulators based upon Group III-V semiconductor materials have been developed for phase and intensity modulation.

The basic element of these latter modulator devices is the guided wave Mach-Zehnder interferometer. These devices can be regarded as a pair of parallel optical waveguides fed by a splitter and leading to a recombiner. The two parallel waveguides are formed of a material with electro-optic properties; that is a material whose refractive index can be varied in response to an electrical field (E-field) across the material.

The speed of light in a material is inversely proportional to the refractive index, n, of the material through which the light is propagating. Thus if the light passing through one of the parallel waveguides encounters a different refractive index, n, compared to light passing through the other, it is differentially delayed or shifted in phase. When the light from the parallel waveguides is suitably recombined the resultant coherent interference can be arranged to provide intensity modulation of the original light source.

Because the change in n with application of an electric field is very rapid in a suitable electro-optic material, the modulator can be used to modulate at very high frequencies, up to beyond 100 GHz.

Modulators based on Mach-Zehnder interferometers have been developed in both the non-semiconducting ferro-electric materials such as lithium niobate and in semiconducting materials, especially the III-V semiconductors such as GaAs/AlGaAs materials. Both lithium niobate and gallium arsenide modulators have been traditionally based upon waveguides made of bulk material.

In recent years a great deal of interest has been shown, both theoretically and practically, in quantum well, quantum wire, and quantum dot containing materials. However, there is as yet no universally accepted and adopted nomenclature for these types of materials, for example these types of materials are sometimes referred to as low dimension carrier confinement materials and other terms are also used. For clarity, therefore, in this specification there will be used three defined terms: quantum wells, which will be referred to as QWs, quantum wires, and quantum dots, which will be referred to as QDs.

In this specification the term QW is used to mean a material having a layer of narrow band-gap material sandwiched between layers of wide band-gap material, with the layer of the narrow band-gap material having a thickness dₓ of the order of the de Broglie wavelength λ_{dB} and the other two dimensions d_{y} and d_{z} of the layer of narrow band-gap material being very much greater than λ_{dB}. Within such a structure, the electrons are constrained in the x dimension but are free to move in the y and z dimensions. Typically, for III-V material, the thickness of the layer for a QW material would be in the range ˜50 Å to ˜300 Å.

If now the thickness of the layer dₓ is reduced to a minimum to give the QW effect, then there is only room in the QW for one energy level for the electrons. An over all QW may have some regions of one energy level only and some regions of a few energy levels.

If the QW is now considered as having a second dimension, say d_{y}, cut down to the size ˜λ_{dB}, so that both dₓ and d_{y} are ˜λ_{dB} and only d_{z} is very much greater than λ_{dB}, then the electrons are constrained in two dimension and thus there is, in effect, created a line in which the electrons can freely move in one dimension only, and this is referred to herein as a quantum wire.

If now the quantum wire is further constrained so that d_{z} is also ˜λ_{dB}, then the electrons are constrained within a very small volume and have zero dimension to move in. This is called herein a quantum dot (QD).

Thus if dₓ, dy, and d_{z} are all very much greater than λ_{dB} the material is simply considered as a bulk material with no quantum effects of the type discussed herein. If dₓ˜λ_{dB} there is provided a quantum well, QW. If dₓ, dy˜λ_{dB}, there is provided a quantum wire, and if dₓ, d_{y}, and d_{z} are all˜λ_{dB}, then there is provided a quantum dot, QD.

The technology for producing QWs is well known but quantum wires have yet to be produced on a commercial scale. In practise they have been formed in the laboratory by electrically constraining a QW structure with electrical fields, or by so called V-growth, but these are not yet a practical commercially available processes.

The present invention is concerned with the use and application of QD materials in modulators. Production processes for QD materials are well established. Two main processes have been developed, chemical etching and self-assembly, and the self-assembly process will be explained in more detail below.

QD materials have been widely suggested for use in lasers, see for example D Bimberg et al, Novel Infrared Quantum Dot Lasers: Theory and Reality, phys. stat. sol. (b) 224, No. 3, 787-796 (2001). Principally they have been suggested for use in the light creating lasing section of a laser because they can produce light of a very narrowly defined wavelength, with a very low threshold current and QD materials have a very high characteristic temperature so as to give a temperature stable laser emitter. Because of these very significant benefits, most of the work on QD materials in laser applications has concentrated on their use in the emitter. The invention described pertains to using quantum dot material within an electro-optic modulator.

### APPLICATION OF THE INVENTION

The present invention is directed to directed to the use of materials modulators. Such modulators may be used in MZI format, or in a variety of other known electro-optic modulator systems as described in Chapter 9, “Optical Electronics in Modern Communications”, A Yarif, Oxford University Press, ISBN 0-19-510626-1.

The essence of the present invention is the enhancement of the linear electro optic coefficient (LEO) in a bulk semiconductor material and especially in a III-V semiconductor (e.g. GaAs) by the use of quantum dots. The LEO can be regarded as a means of varying the refractive index (RI) of the material under the effect of an electrical field normally created by an applied voltage.

In general there are two contributions to the refractive index change Δn under an applied electric field F: the linear contribution due to the Pockels effect and quadratic contribution due to the Kerr effect. These are represented in the equation:
Δn=−½n₀³[rF+sF²]≡Δn_{L}+Δn_{Q} (1)
where r is the linear and s the quadratic electro-optic coefficient, F is the applied field, and n₀ is the refractive index of the material at zero field, and Δn_{L} and Δn_{Q} are the linear and quadratic contributions to the change in refractive index respectively.

In bulk III-V semiconductors, the LEO at optical wavelengths is mainly caused by the distortion, (i.e. polarisation) of the tightly bound core electrons in the semiconductor atoms on the application of an electric field. These are strongly bound and the effect is proportionately weak. This leads to the need for high drive voltages and long active regions to build a large enough phase change and effect modulation. Notably, the weakly bound valence electrons do not contribute significantly because they form a conduction band and flow away when a field is applied and do not add to the local dipole moment or polarisation.

At the same time an important feature of LEO effect is that it is not highly dependent upon the wavelength of the modulated light hence, a device using the LEO effect is capable of broad bandwidth modulation of light. Specifically, such modulators have been developed using bulk GaAs material as described in “High-Speed III-V Semiconductor Intensity Modulators”, Robert G Walker, IEEE Journal of Quantum Electronics, Vol. 27, No. 3, March 1991, pp 654-667.

But an adverse feature of existing III-V semiconductor LEO effect modulators are their necessary length, typically 30 mm, due to the weak LEO effect, and the usual need to achieve a high depth of modulation.

An alternative approach in electro-optic modulator design is to use the quadratic term, Δn_{Q}, of the refractive index change equation (1). This effect is strong only within a very narrow wavelength range, and importantly, it is always accompanied by high absorption of the carrier light. In fact, such modulators are characterised as electro-absorption modulators. Consequently, devices relying on the quadratic effect will modulate light of only a specific wavelength range, and over a very narrow bandwidth. The quadratic effect can be enhanced using quantum well material instead of bulk materials.

InGaAsP/InP quantum well based electro-absorption modulators have been developed for modulation of the important 1.55 μm telecommunication wavelengths. In comparison with GaAs technology InP material and processing is significantly more expensive and does not lend itself to further monolithic integration of optical devices.

Ideally a telecommunication light modulator will have the positive features of each of the above, and none of their disadvantages. These can be summarised as:

a. wide modulation bandwidth

b. low light wavelength dependency giving wide optical bandwidth covering for example the C and/or L communication bands

c. low operating bias and/or small physical size

d. compatibility with monolithic integration

e. low fabrication cost.

These advantages are all realised in accordance with the invention using QDs operating to enhance the electro-optic properties of III-V semiconductor material, in particular gallium arsenide.

QDs are little boxes of narrow band-gap material formed inside the bulk III-V material. They confine these weakly bound electrons and their corresponding holes (in the valence band) and do not allow them to conduct. They are, in essence, artificial atoms. When a field is applied, these weakly bound carriers contribute a large dipole moment, or polarisation and hence a large LEO. In addition the shape of the quantum boxes also leads to a built-in dipole moment before the field is applied and this enhances the LEO further. Initial results obtained by using the invention show that the LEO in the dot system is enhanced over the bulk GaAs system by around 200 times (see below).

Even allowing for the reduced overlap of the light field in the dilute layers of dots (compared to the bulk material) this still leaves a factor of at least 5 or 6 in the net effect. The effect can be further enhanced using a plurality of layers of self assembled quantum dots. This means that the modulators of the invention can be made 5 times shorter, or can be operated at voltages reduced by a factor of 5, or a combination of both. These factors are very significant given that a typical traditional GaAs semiconductor modulator is 30 mm long, and has a bias/drive voltage of several volts, and thus require complex design very wide bandwidth r.f. travelling wave drivers. The invention leads to miniaturisation, energy saving and a reduction in the complexity of the drive electronics (and therefore cost).

For the reasons given above the invention is particularly concerned with modulators which exploit the linear part rather than the quadratic part of the electro-optic effect. The quadratic part is strongest at wavelengths near the band-gap but suffers from high absorption and narrow optical bandwidth, as stated above. The LEO has a wide optical bandwidth and as it is operated well away from the band-gap there are low losses in addition to wide bandwidth utilisation.

Use of QDs to enhance the quadratic effect is known from work done on electro-absorption modulators—see, for example, Photonics Technology Letters, Nov. 1996, Vol. 8, Iss. 11, pp. 1477-1479, Sahara et al. Essentially this work has been a natural extension to the use firstly, of bulk semiconductor materials, secondly, to use the performance enhancement of quantum well materials, and then to the use of quantum dot enhanced materials, for this class of electro-absorption modulators. But even with the third category of materials it does not overcome all the disadvantages of electro-absorption type modulators such as narrow light wavelength range, narrow modulation bandwidth and deterioration of light output due to the high absorption.

Conversely, the present invention addresses all the features desired for a light modulator as listed in a.-e. above, by virtue of working with the linear term (Δn_{L}), of the refractive index change equation (1), to provide the necessary enhancement to the LEO effect.

Electro-optic phase and amplitude modulators are an indispensable part of a modern integrated broadband telecommunication system. For efficient long-range transmission these systems mainly use light signals with wavelength in the erbium doped fibre low loss window around λ=1.55 μm. High-speed modulation over a broad range of wavelengths is required within this broad optical wavelength range. This is the case for example, in the photonic transmitters with external modulation in a WDM system.

Successful operation of the electro-optic modulators within a broadband range requires the utilisation of technologically appropriate materials with suitable dispersion of their electro-optic coefficients. When an external electric field is applied to such a material it causes a change in the material refractive index. In turn, the refractive index change results in a change of the conditions for the light propagation in the medium thereby affecting the output characteristics of the beam.

The invention, by using Quantum Dots (QDs) material to enhance the linear electro-optic effect permits improvements in the performance of electro-optic modulators, allowing them to be made shorter and/or lower voltage, and to operate over a broad range of wavelengths. Prior art proposals of modulators not using QDs, in particular in the InP systems which have different band-gap characteristics to GaAs materials, focuses on operation within the region dominated by the quadratic term of the equation (1), but these prior art systems offer increased electro-optic coefficient only at the expense of increased loss and decreased optical bandwidth. The present invention, which enables operation within the linear part of the operation range offers increased coefficient without the loss and bandwidth penalty.

### BRIEF DESCRIPTION OF THE INVENTION

By the present invention there is provided a modulator formed of a semiconductor material which utilises the electro-optic effect to achieve a change in the refractive index of the material (Δn) under the influence of an applied field, F, in accordance with the equation:
Δn=−½n₀³[rF+sF²]≡Δn_{L}+Δn_{Q}
where n₀ is the refractive index of the material at zero field, and Δn_{L} and Δn_{Q} are the linear and quadratic contributions to the change in refractive index respectively, r is the linear electro-optic coefficient of the material and s is the quadratic electro-optic coefficient of the material incorporating a plurality of quantum dots and operating in a wavelength region where the value of rF is sufficiently greater than the value of sF² so as to operate with the dominant effect on Δn being contributed by the linear effect.

The invention also provides an integrated optical device including a path carrying an incoming optical signal of a wavelength λ, means for directing at least part of the signal via a modulation region, and a path for an optical signal;

the modulation region being formed of a semiconducting material incorporating a plurality of quantum dots and exhibiting an electro-optic response thereby to permit variation of the refractive index of at least part of the modulation region;

the band-gap of the semiconducting material incorporating the quantum dots being such that the corresponding wavelength λ_{g} is less than λ.

In another form, the invention provides an integrated optical device including a path carrying an incoming optical signal of a range of wavelengths between λ₁ and λ₂, means for directing at least part of the signal via a modulation region, and a path for an optical signal;

the modulation region being formed of a semiconducting material incorporating a plurality of quantum dots and exhibiting an electro-optic response thereby to permit variation of the refractive index of at least part of the modulation region;

the band-gap of the semiconducting material incorporating the quantum dots being such that the corresponding wavelength λ_{g} is less than both λ₁ and λ₂ by an amount sufficient that the change in refractive index at λ₁ and λ₂ is substantially the same.

In this way, a device with a wide bandwidth is achieved by appropriately separating the band-gap wavelength and the operating wavelengths. As the separation increases, the slope of the linear effect with wavelength decreases and thus the difference in refractive index (which leads to dispersion) at λ₁ and λ₂ decreases. Experimental results for GaAs material given in “Analysis and Design of High-Speed High Efficiency GaAs—AlGaAs Double Heterostructure Waveguide Phase Modulator”, Sang Sun Lee, Ramu V. Ramaswany and Veeravana S. Sundaram, IEEE Journal of Quantum Electronics, Vol. 27, No. 3, March 1991, suggests that in the dominant linear effect region the variation of the linear effect term Δn_{L}, is less than 0.1% per nanometre of wavelength change when operating in the range of wavelengths covering the telecommunication C and L-Bands (substantially 1530 nm to 1610 nm). By comparison the same data suggests that in this wavelength region the variation of the quadratic effect term Δn_{Q}, is greater than 1% per nanometer of wavelength change. To give a useful operating bandwidth, it is further preferred that the difference between λ₁ and λ₂ is greater than 1 nm.

The present invention further provides a modulator in which the modulator is a Mach-Zehnder Interferometer for modulating a beam of laser light, the modulator including a pair of separate waveguides through which the laser light is passed after splitting in a splitting zone and after which the light is recombined in a merge zone, there being provided opposed pairs of electrodes electrically located so as to be able to effect optical changes within the material of the waveguides, the waveguides being formed of one of the semiconductor materials defined above.

The Mach-Zehnder Interferometer may be a push-pull modulator.

The semiconductor material may be a III-V semiconductor material, which may be based on a system selected from the group GaAs, InAs based materials and InP based materials.

The band-gap wavelength λ_{g} of the quantum dots may be smaller than the wavelength of the light modulated by the modulator. It is preferred that the band-gap wavelength λ_{g} is separated from the operating wavelength(s) of the modulator. Thus, the band-gap wavelength λ_{g} is typically 100 nm shorter than the wavelength of the light modulated by the modulator. Other suitable separations are achieved if λ_{g}, is less than 90% of λ and/or if λ_{g} is less than 1400 nm in which case normal optical signals in the region of 1550 nm are suitably separated.

The quantum dots are self-assembled quantum dots. The self-assembled quantum dots may be formed of InAs based material in host GaAs based semiconductor material, or of InGaAs based material in host GaAs based semiconductor material.

The self-assembled quantum dots may be formed of InAs based material in host InₓGa₁₋ₓAs_{y}P_{1-y} based semiconductor material, or of InGaAs based material in host InₓGa₁₋ₓAs_{y}P_{1-y} based semiconductor material.

The quantum dots may be formed by a chemical etching process.

There may be a plurality of layers of quantum dots.

### DESCRIPTION OF THE PREFERRED EMBODIMENT OF THE INVENTION

The invention will now be described with reference to the accompanying drawings of which:

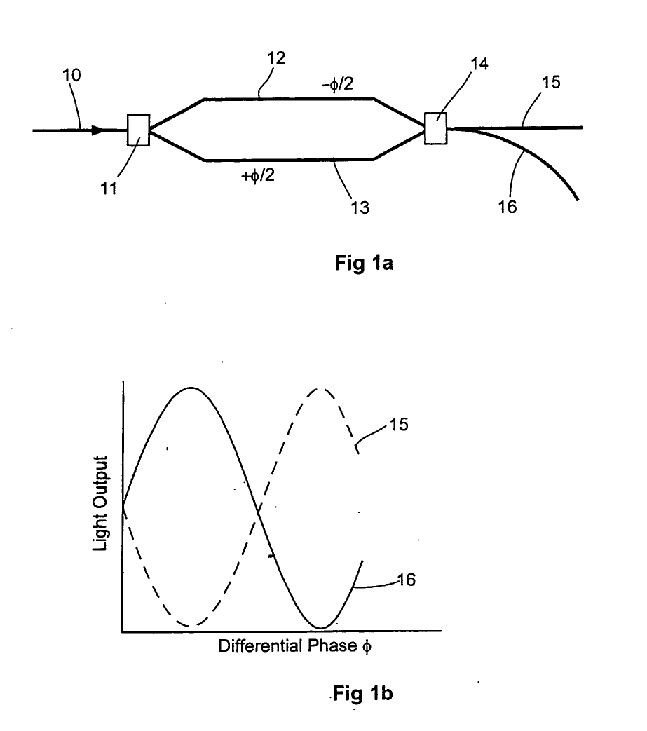

FIG. 1a. is a plan schematic view of a Mach Zehnder Interferometer (MZI),

FIG. 1b. is a graph of light output vs. differential phase,

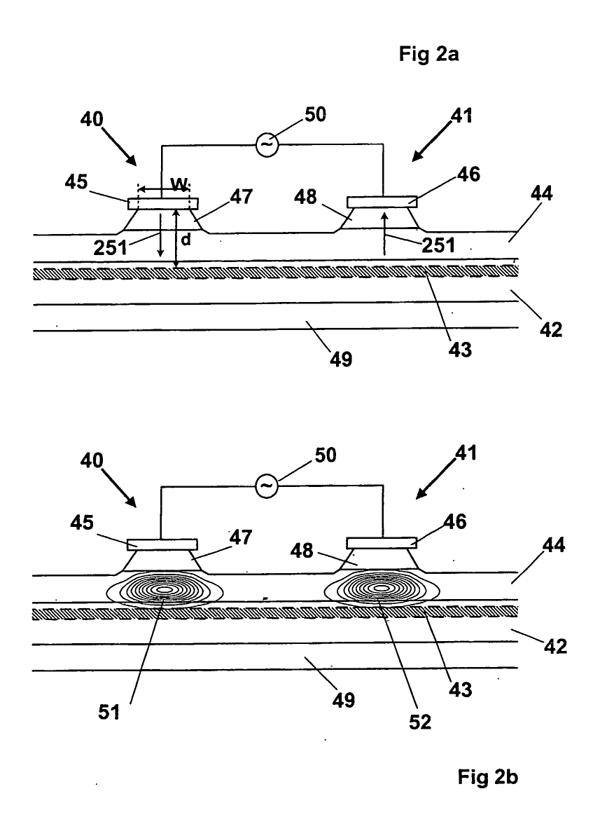

FIG. 2a. illustrates a cross section of a part of a series push-pull modulator based in semiconductor,

FIG. 2b. shows a cross section of a part of a series push-pull modulator based in semiconductor detailing the guided light profiles, and

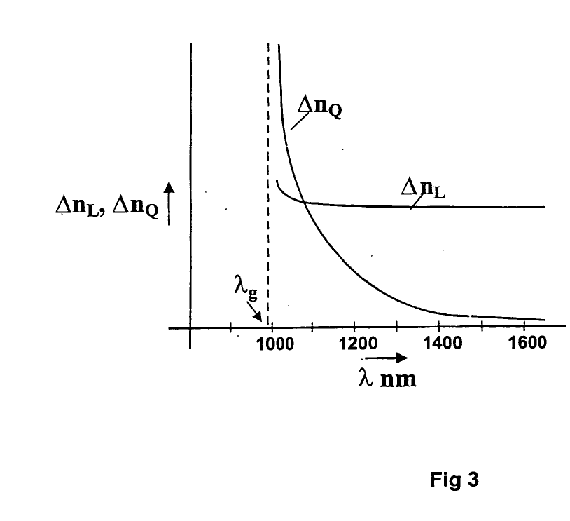

FIG. 3. is a graph of the values r and s against wavelength λ.

### DETAILED DESCRIPTION OF THE EMBODIMENTS

For ease of understanding, the invention will firstly be described with reference to an MZI format modulator, although it has wider uses than in MZIs alone and may be used in a variety of other known electro-optic modulator systems as described in Chapter 9, “Optical Electronics in Modern Communications”, A Yarif, Oxford University Press, ISBN 0-19-510626-1.

Referring to FIG. 1a. this shows a general view of an MZI in which an incoming light beam from free space or an optical waveguide 10 is split by splitter 11 so as to pass through two parallel waveguides 12 and 13. The light is then recombined by recombining unit 14 and is outputted via a signal line 15 and a dump or monitor line 16.

By differentially phase shifting or delaying the light in waveguide 12 compared to the light in waveguide 13 as shown in FIG. 1b., for example so that the light in path 12 is phase shifted by +φ/2 and the light in path 13 is phase shifted by −φ/2, the light when recombined can be apportioned between output lines 15 and 16 according to the phase shift. A suitable degree of phase shift can result in the routing of the light entirely from one port to another in a cyclical manner. If the differential changes to the light in the paths 12 and 13 is carried out by, or in response to, a desired signal, this apportioning results in modulation at one or other port. There are several structures available for this recombination, examples of which include directional couplers and Y-junctions and multi-mode interference couplers. In three port couplers such as a Y-junction, the second port 16 is comprised a free radiation.

The waveguides are provided with electrodes to establish the required electric fields across the waveguides. The linear electro-optic effect naturally provides a refractive-index change whose magnitude and direction is sensitive to the orientation of the applied electric field. Thus, beneficially, the E-field can be dropped across the two waveguides in opposing directions in order that one will experience phase retardation while the other experiences a phase advance of equal magnitude. This is known as a push-pull modulator. Because the light is passing along a material of higher refractive index than air, it is slowed down within the waveguide by an amount proportional to n/n₀, where n is the refractive index of the material and n₀ is the refractive index of air.

In this design, the electrical transmission lines, which form the electrodes providing the field, are superimposed on the optical waveguide.

The linear electro-optic effect naturally provides a refractive-index change whose magnitude and direction is sensitive to the orientation of the applied electric field. Thus, beneficially, the E-field can be dropped across the two waveguides in opposing directions in order that one will experience phase retardation while the other experiences a phase advance of equal magnitude

FIG. 2a. is a cross-section of a basic Mach-Zehnder interferometer modulator fabricated in the GaAs/AlGaAs (gallium arsenide) material system. A GaAs substrate 49 has formed on it a sequence of AlGaAs and GaAs layers to form a 1D (slab) optical waveguide. The refractive index of AlGaAs is lower than that of GaAs (the difference increasing with the aluminium content of the AlGaAs); accordingly the layer-sequence comprises:
i. An AlGaAs lower-cladding layer 42, sufficiently thick to prevent optical leakage into the high-index substrate
ii. A GaAs core layer 44 within which the light is largely confined.
iii. An AlGaAs upper cladding layer (47, 48) whose composition need not be the same as that of the lower cladding.

In semiconductor materials, it is possible to define regions of electrical conductivity by means of impurity doping. Accordingly, there is superimposed onto the refractive-index profile due to the aluminium content, an independent conductivity profile due to impurity doping. Here, n-type doping, providing a surplus of free electrons, due to traces of silicon is used to provide a conductive region 43 beneath the plane of the waveguides. This may be wholly within layer 42, as drawn, or may straddle the layer 43/44 interface depending upon the desired device characteristics. Moreover, the doped region may contain a diversity of conductivities if desired in order to optimise the properties of the structure. The bulk of the waveguide is comprised of undoped material, having background free-carrier levels only.

Lateral confinement of the light is due to etched ribs 47 and 48. Typically, but not of necessity, a pattern of deposited metal electrodes, 45 and 46, may be used as the etch-mask to define these ribs, thereby providing self-aligned electrodes for the electro-optic functionality. Where electrodes are not required they are subsequently removed by selective etching using an etchant to which the semiconductor is impervious.

Alternatively electrodes 45 and 46 may be deposited by any convenient means onto pre-existing waveguides.

Electrodes 45 and 46 comprise metal-to-semiconductor contacts that, on undoped AlGaAs, possess rectifying (Schottky) properties. When reverse-biased, electrodes 45 and 46 are negative with respect to the doped layer 43, residual free-carriers are depleted from the undoped waveguide regions and the electric-field falls directly through the waveguide terminating at the doped layer 43.

In InP-based III-V semiconductor systems, it may be desirable to apply p-type doping to the rib surface below the electrode as good rectifying metal-to-semiconductor junctions are otherwise difficult to achieve in those materials.

FIG. 2b. shows the location of the guided light in the active GaAs core layer 44. The regions of contoured lines 51 and 52 show the light intensity profile. The profiles show that the vertical confinement of the light is tighter than the lateral confinement and that the lateral spread of the light is beyond the “confines” of the etched rib of AlGaAs.

As shown in FIGS. 2a. and 2b., the two waveguides are thus connected back-to-back by the conductive doped n-type buried-layer. Layer 43 acts as the back contact for the top electrodes 45 & 46, these being rectifying metal-semiconductor contacts.

In operation the entire structure is electrically biased so as to maintain full depletion of carriers from the zones between 45 & 43 and 46 & 43. The electric field is thereby confined to the immediate vicinity of the guided light resulting in the highest possible electro-optic efficiency. The AC signal applied by generator 50 results in an AC ripple superimposed on the DC bias. This means that the field is always in the direction of arrows 251 (FIG. 2a).

At high alternating signal frequencies, the depleted regions with their contacts 41, 40 and 43 act as capacitors, series connected across the RF supply. If these capacitances are equal, then half of the RF voltage is dropped across each respectively. Because of the directionally folded electrical path the resultant electro-optic effect within the two guides is anti-phase i.e. the optical phase of one guide is advanced while that of the other guide is retarded.

When both electro-optic waveguides are contributing equally to the differential phase shift the modulator is said to operate in push-pull mode. The equal capacitive electrodes are series-connected across RF source, thus the effective capacitance is just half that due to each and the RF potential divides equally between the two sides. This balanced or anti-phase phase modulation produces full intensity modulation upon recombination of the two paths at the output optical coupler, but without residual phase modulation, known as chirp.

The effect of the field established by the electrodes 45 46 across the modulator is to vary the refractive index in accordance with equation (1) above:
Δn=−½n₀³[rF+sF²]≡Δn_{L}+Δn_{Q}

However, the values of both r and s are only constant at a given wavelength and the variation in both r and s with wavelength λ is as shown in FIG. 3. It can be seen from this equation that both r and s decrease with increasing wavelength away from the characteristic wavelength λ_{g}, but that the value of s varies very significantly with wavelength whereas the value of r varies only by small amounts with wavelength.

The characteristic wavelength, λ_{g}, is defined as follows. The band-gap is the energy difference ΔE_{g} between the electrons in the valence band and the electrons in the conduction band. If such a material is illuminated with light at a plurality of wavelengths, then light at certain wavelengths will raise the energy of some of the electrons in the valence band and raise them up into the conduction band. If those electrons then fall back into the valence band from the conduction band, they each will emit a photon of a wavelength λ_{g} which is related to the energy difference between the two bands, ΔE_{g}, defined as:
λ_{g}=h c/ΔE_{g}
where h is Planck's constant, and c is the velocity of light in the material. This is referred to as the band-gap wavelength or sometimes the band edge wavelength.

Given that the Δn varies only with the first power of F in the portion of the equation concerned with r (Δn_{L} term) but with the square of F in the portion concerned with s (Δn_{Q} term), and given that the wavelength λ_{g} corresponds to the band-gap energy for the semiconductor material of the modulator, it can be understood why effort has been focussed on enhancing the electro-optic effect by utilising the quadratic term in equation (1) Δn_{Q}, for example, in light electro-absorption modulators such as described in “Fibre-Optic Communication Systems” by G. P. Agrawal, published by John Wiley and Sons, 1997, page 127, but the penalty is increased light absorption.

The invention operates in the regions where the linear optic effect r is dominant, and in so doing obtains many significant advantages.

To understand how the invention does this, we will now review firstly the connection between band-gap width and wavelength and then the effect of a QD structure in a semiconductor material.

If we now consider a QD structure, as mentioned above, this effectively comprises a plurality of small, notionally zero dimension regions, in a host of bulk semiconductor material. These regions are capable of capturing and confining carriers (electrons and/or holes) as described in “Quantum Dot Heterostructures” by D. Bimberg, M. Grundmann and N. N. Ledentsov, published by Wiley, Chichester 1999, chapter 1. The mechanism of electro-optic effect enhancement is described below.

Two main methods of producing such structures have been developed and are described in chapter 2 of the above reference. The first is to produce a flat relatively thick layer of bulk wide band-gap material and to deposit on it a thin layer of narrow band-gap material each of appropriately chosen lattice constant and band-gap. The thin layer of narrow band-gap material is then covered with a layer of photo-resist, and exposed to form a pattern of dots. The unwanted material is then chemically etched away and the photo-resist is then stripped off. Another thick layer of bulk material is applied and the process is repeated as often as is required.

A preferred alternative method for forming the QDs is, however, the self-assembly method (SAQDs) as described in chapter 4 of the Bimberg, Grundmann and Ledentsov reference above. In this process a thin layer of, for example, InAs, is grown rapidly onto a thick bulk layer of, for example, GaAs. This can be done using either molecular beam epitaxy (MBE) or metal organic vapour phase epitaxy (MOVPE). MOVPE is also sometimes called metal organic chemical vapour deposition (MOCVD).

The amount of the InAs is so controlled as to exceed a critical thickness at which point the grown layer splits into isolated dots as a consequence of the strain between the InAs and the GaAs, of our example, and the growth conditions. These dots can be further overgrown by a further layer of GaAs, and then further InAs dots grown as described. This can be repeated for a plurality of layers. This results in a plurality of layers of individual quantum dots (QD).

MOVPE can be used, as is known, to create QDs on an industrial scale. The QDs are self-assembling and typically contain a few thousand of molecules and are normally very flattened pyramids. The ratio of the thickness d to their height h is normally in the range of 5 to 100. Since they are self assembling, the dimensions of each dot cannot be separately controlled, however, it is known that the average size and density of dots can be controlled technologically and manufactured reproducibly.

We now discuss how such QDs can be used to enhance the linear electro-optic effect. In equation (1) above the linear effect Δn_{L} is mainly associated with the core electrons in bulk material. In a semiconductor, the core electrons stay on the lattice, whilst the valence electrons go off into the conduction band and become conduction electrons if they attain an energy level sufficient to pass across the band-gap. These electrons are free to move throughout the material and provide electrical conduction.

In a QD material the conduction electrons on atoms within a quantum dot cannot get away from the quantum dots, as they cannot attain sufficient energy to overcome the additional confinement energy of the quantum dot. The outer band electrons are confined to the dot and are not free to move through the host semiconductor material and provide electrical conduction.

When an external field is applied to the structure of a semi-conductor, the field distorts the atoms and it is this distortion that actually causes linear variation of the refractive index. In a bulk material the applied field has to interact with the valence electrons, which are strongly bound to the nucleus of the atoms, so the distortion is relatively small. However, in a QD the outer conduction electrons are locked into the dot. The QD behaves like an artificial atom. When an electric field is applied the conduction electrons confined within the QD behave like very loosely bound core electrons. The dot is therefore a very highly polarisable artificial atom. This unique characteristic of quantum dots (QD) distinguishes them over all other bulk, quantum well or quantum wire semiconductor materials.

As a consequence of the above the linear electro-optic effect within a QD layer is much greater than in bulk material. For example, in InAs dots in GaAs the enhancement factor is typically 200 as described in the Journal of Vacuum Science and Technology, B 19 (4) 1455, 2001. Even though current technology permits a packing density such that only 3% of the volume of a structure can be formed of QDs, this still means that the overall increase in the linear effect is 3% of 200, i.e. about six times greater. The effect can be further enhanced by incorporating a plurality of quantum dot layers.

This means that compared to bulk material a QD material would be typically six times or more effective as a modulator using the QD material in the regions 51, 52. Thus the modulators of the invention could either be the same length as at present, but operate with one sixth the energy input and thus one sixth of the heating load and power consumption, or could be only one sixth as long.

The reason for this is that the optical phase retardation, ΔΦ, due to propagation of a light beam through a medium is proportional to both refractive index change Δn, and the modulator's length L:
ΔΦ=(πL/λ₀)Δn (2)

It follows from the above expression that a weak electro-optic effect (small Δn) will require a large modulator dimension L in order to achieve the required phase retardation. In addition to this, for long modulators it is necessary to take into account the finite time of the light propagation through the electro-optically active medium. This in turn requires complex electronic travelling wave circuitry in order to synchronise the optical and the applied electric fields as they travel along the modulator.

GaAs modulators not incorporating QDs and using this linear electro-optic effect have, nevertheless, been successful and are the basis of the currently commercially available GaAs/AlGaAs modulators. However because the effect is weak they have to be quite long (several centimetres in some cases) to allow the effect to build up, and have to be driven at high voltage (several volts at worst).

Thus by creating the optical modulating sections 51, 52, of SAQD material the advantages set out above can be obtained in a modulator which can switch at very high speeds, below a hundred picoseconds.

In more detail, as explained briefly above, the physical origin of the linear electro-optic effect (LEO) is different from that of the quadratic electro-optic effect. In general in bulk materials there are two contribution to the LEO effect. The first arises from the effect of the external electric field on the core electron states. This results in polarisation of the electronic distributions of bound electrons on the internal atomic shells. This is a pure electronic contribution and it can be expressed through the derivative of the susceptibility χ with respect to the electric field F. The second contribution to the LEO effect is due to the polarisation of the ionic lattice of the semiconductor and it is related to the derivative of the susceptibility with respect to the ionic displacements.

Because the above two contributions are characterised by different oscillation frequencies they will contribute to the LEO effect within very different light wavelength ranges. In particular the natural frequency of the lattice contribution is the phonon frequency. The highest polar optical phonon frequency in III-V semiconductors lies below 10 THz. This frequency is about two orders of magnitude lower than the frequency of the light with λ=1.5 μm. Therefore in the majority of cases one can safely ignore the lattice contribution to the LEO effect at light wavelengths of interest for telecommunications.

The corresponding oscillation frequency of the core electronic shell vibrations is considerably higher. It is this contribution to the LEO effect which is of most interest within a very wide communications wavelength range around 1.55 μm. Besides the above electronic oscillation frequency, another important parameter, which characterises the strength of the polarisation response of the tight-bound electrons is the corresponding elastic constant defining the interaction force between the core electrons and the nucleus of the atom. This interaction is responsible for the atomic stability and is therefore very strong. This is why an external electric field perturbs the core electron distribution in the atom only slightly. As a result of this the corresponding LEO coefficients are quite small. Therefore, for enhanced LEO effects materials should preferably be used which have the strength interaction for core electrons as weak as possible.

The most important property of the LEO effect is its wavelength dispersion. It is well known that the effect exhibits relatively low dispersion near the material band-gap energy and it remains almost constant at wavelengths far away from the band-gap. In this respect the LEO effect behaviour is fundamentally different from that of the quadratic electro-optic effect. At the same time, as discussed above, at the light wavelengths near the band-gap the quadratic electro-optic effect is much stronger than the LEO effect and it dominates the contribution to the refractive index modulation under the external electric field, but this is at the expense of very strong light absorption. Therefore in order to obtain wide band operation it is preferable to work well away from the band-gap thus avoiding losses and try to enhance the LEO effect, in order to provide the necessary modulation. This is the possibility presented by quantum dots.

In order that optical losses near the band-gap edge are avoided, it is preferred that QDs are used with a band-gap energy larger than the energy of the emitted photons. As naturally grown In(Ga) As/GaAs SAQDs have a band-gap energy corresponding to the wavelength of 1200 to 1330 nm, which is far away from the wavelength of 1550 nm used in the telecommunication C-band, this a very suitable system.

Present technology permits the creation of QDs using a wide range of III-V semiconductor materials. This permits the invention to be used in the modulator waveguides based on many otherwise suitable materials. The number of stacked layers is only limited by the technology available at the time of utilisation of the invention.

As mentioned above, and as shown with reference to FIG. 3., the linear effect is relatively independent of the wavelength compared to the quadratic effect. Thus the modulators can operate with very level characteristics over wide bandwidths when operating in the LEO mode, and without detrimental absorption of light.

The invention thus provides a significant number of benefits, including:
a) Considerably smaller dimensions for the QD-based electro-optic modulators in comparison with bulk modulators (the reduction factor of about 5-10 times is possible in comparison with GaAs bulk modulators);
b) Reduction of the operational bias voltage;
c) Simplification of the electronic circuitry which operates the modulators (as it is possible that there will be no necessity to use traveling wave electrical feed lines);
d) Increase of the modulation speed;
e) Decrease of the RF power consumption in the modulator;
f) Broad optical band operation, similar to that obtainable with bulk GaAs modulators whilst obtaining wider than band edge modulators such as those available with InP modulators;
g) Low loss structures similar to bulk GaAs and better than band edge modulators such as those in InP.

1. A modulator device formed of a semiconductor material which utilises the electro-optic effect to achieve a change in the refractive index of the material (Δn) under the influence of an applied field, F, in accordance with the equation:
Δn=−½n₀³[rF+sF²]≡Δn_{L}+Δn_{Q}
where n₀ is the refractive index of the material at zero field, and Δn_{L} and Δn_{Q} are the linear and quadratic contributions to the change in refractive index respectively, r is the linear electro-optic coefficient of the material and s is the quadratic electro-optic coefficient of the material incorporating a plurality of quantum dots and operating in a wavelength region where the value of rF is sufficiently greater than the value of sF² so as to operate with the dominant effect on Δn being contributed by the linear effect.

2. A device as claimed in claim 1 in which the band-gap wavelength λ_{g} of the quantum dots is shorter than the wavelength of the light modulated by the modulator.

3. A device as claimed in claim 2 in which the band-gap wavelength λ_{g} of the quantum dots is typically 100 nm shorter than the wavelength of the light modulated by the modulator.

4. An integrated optical device including a path carrying an incoming optical signal of a wavelength λ, means for directing at least part of the signal via a modulation region, and a path for an optical signal;
the modulation region being formed of a semiconducting material incorporating a plurality of quantum dots and exhibiting an electro-optic response thereby to permit variation of the refractive index of at least part of the modulation region;
the band-gap of the semiconducting material incorporating the quantum dots being such that the corresponding wavelength λ_{g} is less than λ.

5. An integrated optical device according to claim 4 in which λ_{g} is less than 1400 nm.

6. An integrated optical device according to claim 4 in which λ_{g} is less than 90% of λ.

7. An integrated optical device according to claim 4 in which the difference between λ_{g} and λ is greater than 100 nm.

8. An integrated optical device including a path carrying an incoming optical signal of a range-of wavelengths between λ₁ and λ₂, means for directing at least part of the signal via a modulation region, and a path for an optical signal;
the modulation region being formed of a semiconducting material incorporating a plurality of quantum dots and exhibiting an electro-optic response thereby to permit variation of the refractive index of at least part of the modulation region;
the band-gap of the semiconducting material incorporating the quantum dots being such that the corresponding wavelength λ_{g} is less than both λ₁ and λ₂ by an amount sufficient that the change in refractive index at λ₁ and λ₂ is substantially the same.

9. A device according to claim 8 in which the difference in refractive index at λ₁ and λ₂ is less than 0.1% per nanometer.

10. A device according to claim 8 in which the difference between λ₁ and λ₂ is greater than 1 nm.

11. A device as claimed in claim 1 in which the modulator or modulation region is a Mach-Zehnder Interferometer for modulating a beam of laser light, the modulator including a pair of separate waveguides through which the laser light is passed after splitting in a splitting zone and after which the light is recombined in a merge zone, there being provided opposed pairs of electrodes electrically located so as to be able to effect optical changes within the material of the waveguides, the waveguides being formed of the semiconductor material.

12. A device as claimed in claim 11 in which the Mach-Zehnder Interferometer is a push-pull modulator.

13. A device as claimed in claim 1 in which the semiconductor material is a III-V semiconductor material.

14. A device as claimed in claim 13 in which the III-V semiconductor material is based on a system selected from the group GaAs, InAs based materials and InP based materials.

15. A device as claimed in claim 1 in which the quantum dots are self-assembled quantum dots.

16. A device as claimed in claim 1 in which the quantum dots are formed of InAs based material in host GaAs based semiconductor material.

17. A device as claimed in claim 1 in which the quantum dots are formed of InGaAs based material in host GaAs based semiconductor material.

18. A device as claimed in claim 1 in which the quantum dots are formed of InAs based material in host InₓGa₁₋ₓAs_{y}P_{1-y} based semiconductor material.

19. A device as claimed in claim 1 in which the quantum dots are formed of InGaAs based material in host InₓGa₁₋ₓAs_{y}P_{1-y} based semiconductor material.

20. A device as claimed in claim 1 in which the quantum dots are formed by a chemical etching process.

21. A device as claimed in claim 1 in which there is a plurality of layers of quantum dots.
